(19) United States
(12) Patent Application Publication
(10) Pub. No.: US 2026/0047723 A1
(43) Pub. Date: Feb. 19, 2026

(54) MOTORIZED UTENSIL FOR EASY STIRRING

(71) Applicants: Gwendolyn Jenkins-Allen, Houston, TX (US); Robert L. Allen, Houston, TX (US)

(72) Inventors: Gwendolyn Jenkins-Allen, Houston, TX (US); Robert L. Allen, Houston, TX (US)

(21) Appl. No.: 18/805,520

(22) Filed: Aug. 14, 2024

(51) Int. Cl. A47J 43/044; A47J 43/07; A47J 43/08; A47J 43/28

(52) U.S. Cl. CPC A47J 43/044; A47J 43/0705; A47J 43/082; A47J 43/28; A47J 2043/04418; A47J 2043/04427

(57) ABSTRACT

A motorized stirring system enables users to perform stirring functions with little negative impact on the user's wrist. In active mode, this system rotates a utensil forward or in reverse direction as the user selects. The system incorporates a motor to provide the rotation torque. A shaft that connects to and rotates a stirring element is attached to the motor. The stirring utensil attaches to the stirring element and moves as the stirring element rotates to perform the stirring function. A handle attached to the motor enables the user to hold and control this motorized stirring system.

### FIELD

This invention relates to a utensil for a person who has challenges performing activities that require extensive use of their wrists. More particular, this invention relates a motorized utensil device one can strap or attach to their hand and activate to assist in stirring activities in order to reduce the dependence on their wrist during stirring.

### BACKGROUND

One cannot overstate the significance of using a person's wrist in daily activities. Its mobility, strength, coordination, and stability are integral to performing various tasks efficiently and safely. By understanding the importance of the wrist and taking proactive steps to maintain its health, individuals can ensure their wrists remain functional and pain-free, contributing to overall well-being and quality of life.

Various areas of activities incorporate the crucial functioning of the wrist. In the sports arena, activities such as tennis come to mind. Tasks such as effective serves, the various tennis strokes, and volleys depend on the flexibility of the wrist. In golf, the proper swing mechanics and golf club control rely on the wrist. In baseball and softball, a person's wrist impacts pitching and batting. The wrist action is essential in dribbling and shooting a basketball. In music, playing instruments such as the piano, guitar, violin, and drums require the flexibility of the wrist. In martial arts, techniques and movements often demand wrist litheness. Artists and painters rely extensively on the use of the wrist. Yoga and weightlifting depend on wrist flexibility to perform correctly and adequately.

In addition, everyday activities such as typing or controlling a mouse on a computer for extended periods involve the wrist. Cooking tasks such as chopping and stirring are wrist-intensive. Craft activities, including knitting, sewing, and woodworking, use one's wrist. In healthcare, precise movements in surgery and exercises in physical therapy require substantial wrist movements. Having flexible wrists can enhance performance and reduce the risk of injury in these activities.

Regarding activities and tasks in the kitchen, several cooking activities benefit from having flexible wrists for efficiency and precision. Chopping and slicing using a knife to chop vegetables, fruits, and meats requires controlled wrist movements for safety and accuracy. Stirring and whisking soups, sauces, batters, and whisking eggs or cream needs a flexible wrist for smooth and consistent motion. Rolling dough for pastries, pasta, or pizza involves applying even pressure and smooth rolling actions. Kneading dough for bread or pasta dough involves repetitive motions that can strain the wrists if not done with flexibility and strength. Flipping and turning using a spatula to flip pancakes, omelets, or stir-fry ingredients necessitates quick and precise wrist movements. Kitchen tools in performing tasks like using a peeler, grater, or zester require nimble wrist motions to handle different angles and surfaces effectively. Pouring and transferring liquids from heavy pots or transferring ingredients from one container to another need steady wrist control to avoid spills.

Concerning actions such as decorating and garnishing or piping icing on cakes, the intricate designs require fine wrist movements for detailed work. Using a Wok or Saute Pan to toss ingredients in a pan requires fluid wrist actions to keep the food moving and cooking evenly. Flexible wrists enhance these cooking activities by allowing smoother, more efficient motions, reducing fatigue, and minimizing the risk of repetitive strain injuries.

Because of the wrist's vital role in many cooking activities and for individuals with wrist challenges, using specialized utensils can make cooking more comfortable and accessible. Currently, there are adaptive utensils and tools designed to reduce strain on the wrists. Ergonomic knives are designed with angled and offset handles to keep the wrist in a more natural position. Rocking knives allow cutting with a rocking motion instead of lifting the knife. Comfort grip utensils with large handles and thick cushioned grips are more accessible to hold and require less force. Non-slip handles provide better control and reduce the need for a tight grip. Electric can openers lessen the need for twisting motion. Food processors handle chopping, slicing, and dicing with minimal manual effort. Hand mixers assist with mixing and whisking without manual stirring. Two-handled pots and pans allow for better weight distribution and easier lifting. Ergonomic handles are also designed to reduce strain on the wrist. Tilted mixing bowls keep the bowl steady and reduce the need for wrist movement when mixing ingredients. Utensil Holders and Stabilizers Utensil cuffs hold utensils securely in hand, reducing the need for a firm grip. Stabilizing boards hold utensils in place, allowing one-handed use. These adaptive tools can make cooking more accessible and enjoyable for those with wrist challenges, helping them maintain independence in the kitchen.

Stirring is an everyday activity in cooking that engages the hand, wrist, and arm in a coordinated effort to mix ingredients thoroughly. This seemingly simple task actually involves a complex interplay of muscles, tendons, and joints. Understanding the physical requirements can help in performing stirring activities efficiently and in a way that minimizes strain or injury.

In stirring, a person primarily uses the hand and the wrist. The arm and other muscle groups also have a role during a stirring activity. The hand provides grip strength and gives a person the ability to hold and manipulate a spoon, whisk, or other stirring utensils firmly is crucial. This strength primarily comes from the muscles in the hand and forearm. Stirring often requires precise control, especially when dealing with delicate ingredients or specific mixing techniques. Fine motor skills ensure that the hand can make subtle adjustments as needed.

As previously stated, the wrist provides flexibility. The wrist must have a good range of motion to move in various directions—up and down, side to side, and in circular motions. This flexibility allows for thorough mixing and prevents fatigue from repetitive movements. While flexibility is essential, the wrist must also be stable to control the stirring motion accurately. This stability is maintained by the muscles and tendons surrounding the wrist joint. Wrist endurance is also essential. Prolonged stirring, such as making risotto or continuously stirring a sauce, requires endurance in the wrist muscles to prevent fatigue and maintain a consistent motion.

Using one's hands and wrists in daily tasks may seem so familiar that many people do not consider it. However, for those who suffer from various limitations to their wrists from injury, age, arthritis, or some other condition, daily tasks such as stirring can be a significant challenge. For all of the existing kitchen products available to improve efficiency and foster convenience, these products have not addressed the primary action of individually stirring a drink of substance in a bowl. This situation exists mainly when an individual uses a regular spoon.

One product, U.S. Pat. No. 6,594,908 to Di Amico describes a motorized fork eating utensil. It contains an improved electromechanical motor switching system in the fork's handle. The system comprises a cam attached to an electric motor in electrical contact with a battery power source. This system produces a fork utensil that rotates around an axis in the fork's center. As the discussion mentions, this utensil has applications, for example, when a user is trying to eat pasta such as spaghetti by winding a string of spaghetti around the fork. Although this product has an application, it does not address issues during a stirring activity.

Stirring may seem straightforward, but it involves complex physical requirements for the hand, wrist, and arm. By understanding these requirements and taking steps to reduce strain, you can ensure that your stirring activities are efficient and safe, allowing you to enjoy the cooking process without discomfort. There remains a need for a product that can assist individuals with various adverse or chronic wrist conditions in performing basic stirring activities with ease and efficiency.

### SUMMARY

A motorized utensil enables a person to perform stirring activities without putting extensive stress on a user's wrist. Users can activate this stirring utensil and place it as desired to perform stirring actions. When performing these activities, the user does not rotate their wrist. This utensil can comprise a rotation element connected to a motor to provide power to rotate the element. A utensil such as a spoon is attached to the rotation element to facilitate the stirring. The motor can be contained in a housing the user can hold during these activities. Controls attached to the housing or motor can control the speed and direction of the rotation and start and stop the motor. Various utensils can be connected to the rotation element as desired.

### DESCRIPTION OF THE DRAWINGS

FIG. 1 is view of an embodiment of the motorized stirrer system of the present invention held be a user to assist individuals in stirring activities.

FIG. 2 is a view of the bar and belt elements of the motorized stirrer system of the present invention.

FIG. 3 is a view of the rotating element and utensil of the present invention.

FIG. 4 is a view of an embodiment of the motorized stirrer system incorporating a bar handle.

FIG. 5 is a view of an alternate embodiment of the stirrer system with implementation of a stirring utensil in a downward position.

FIGS. 6A, 6B, 6C and 6D are concept illustration of the motor and stirrer components of the motorized stirrer.

FIG. 7 is an illustration of the gear system that facilitates torque or rotation in the stirring process.

FIG. 8 is a detailed view of an embodiment of the motorized stirrer system of the present invention.

FIG. 9 is a view of the motorized stirrer system being implemented.

### DETAILED DESCRIPTION OF THE INVENTION

The present invention's motorized stirrer system provides a means to perform stirring activities with reduced stress on the person's wrist. This device will be handy for persons who suffer some form of disability with their wrist, such as arthritis, injury, age, or other conditions. The motorized stirrer device will rotate during stirring activity, which is challenging for some people. In the concept of the system, a motor creates a rotation motion. A utensil attached directly or indirectly to the motor will rotate due to the motor's rotation motion. The motor will be able to rotate in a forward or reverse direction as desired by the user.

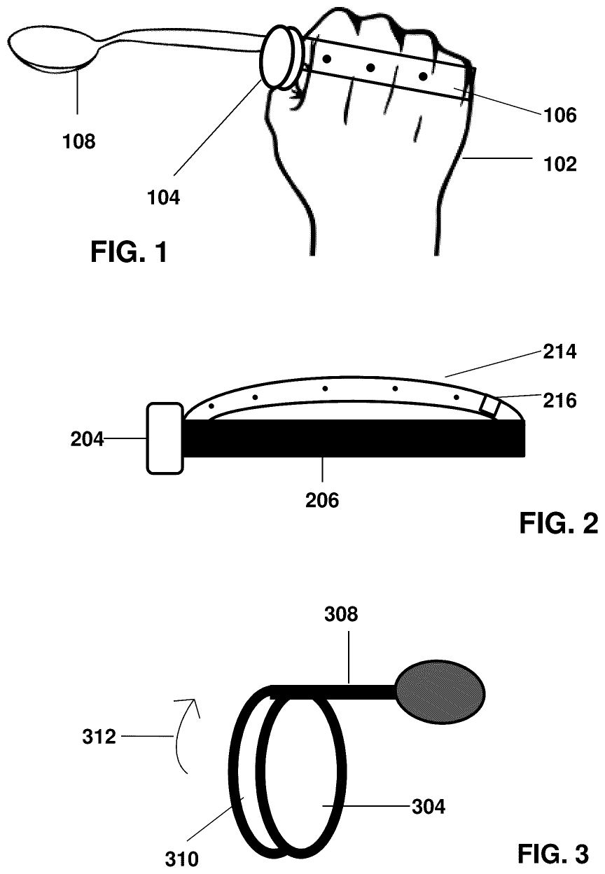

FIG. 1 shows the basic concept of the invention. The user can hold the device in one hand 102. The user grips a handle 106 attached to a rotation element 104. This rotation element can be in the form of a generally round disc with a front side, a back side facing the motor and an edge extending the length of the disc circumference. The stirring utensil would often be a spoon 108 connected to the rotation element. As the rotation element is powered up and begins rotating, the attached utensil rotates to perform the stirring action.

FIG. 2 shows the handle portion of the motorized stirrer system of the present invention. In this embodiment, there is a grip bar 206, which the user will grasp with their hand. A belt 214 of flexible material attaches to the ends of the grip bar. The belt also has attached to it a buckle 216 to enable the user to adjust the length and tension of the belt to the grip bar. The rotation element 204 is attached to one end of the grip bar 206. In various embodiments, the grip bar can be a standalone handle. Also, there can be an embodiment with a belt or strap element as a standalone handle. This element can be of conventional materials such as leather or Velcro. In both cases, the rotation element would still attach to one end of the belt or bar.

FIG. 3 is a view of the rotating element and utensil of the present invention. In the implementation of the present invention, a utensil 308 used for stirring can be attached to a rotation element 304. This rotation element can be a circular disc with an edge 310 through which the utensil 308 will engage and attach to the rotation element 304. This rotation element can be part of the motor device or a separate component attached to the motor. The rotation element can rotate in a forward direction 312 or a reverse direction to facilitate the stirring motion. This rotating element can also be completely solid or it can be internally hollow. This hollow area inside the rotation element can house elements of the rotation system connected to the motor and would facilitate the rotation of the rotating element or disc.

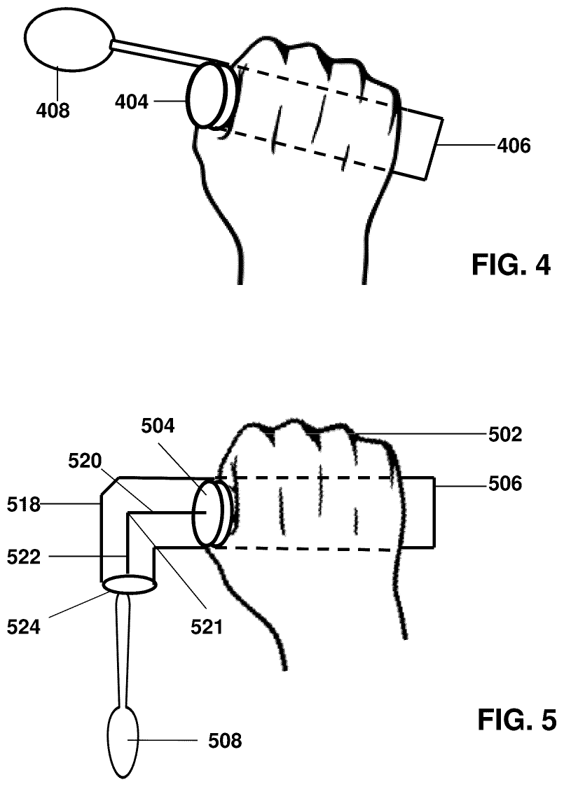

FIG. 4 shows an embodiment of the motorized stirrer system incorporating a bar-only handle. The bar 406 can have a hollow portion at the end that attaches to the rotation element 404. The hollow section of bar 406 would house the motor and power source. A rod or shaft extending from the motor could connect to a rotation element. The user would operate the motor with controllers positioned on the bar. In this manner, the user can control the forward and reverse motion of the utensil 408.

FIG. 5 shows another alternate embodiment of the stirrer system with the implementation of a stirring utensil in a downward position. This embodiment also shows a grip bar 506, only implemented in the user's hand 502. In this configuration, the rotation disc 504 is attached to the motor. Also, the rotation disc attaches to utensil fitting 518. This connector is a component that connects the motor and rotation disc 504 to the utensil 508. This fitting can provide flexibility to allow positioning of the spoon or other utensils at various angles for stirring. Within the fitting 518 can be a rod 520, a second rod 522 connected in a perpendicular configuration 521 to the first rod 520. Attached to the second rod 522 is a second rotation element 524.

The first rod 520, the second rod 522, and the second rotation element 524 are for a gear structure for rotating at various angles and directions. As the rotation disc turns in a circular direction, the first rod 520 can begin to rotate in the same direction as the rotation disc 504. At the connection point, 521 of rods 520 and 522 can be gear discs. The rotation of rod 520 in a vertical direction through the gear system will cause rod 522 to rotate in a horizontal direction, causing the second rotation element and utensil attached to it to rotate horizontally. Stirring is not a one-position activity. Depending on the task, the angle needed to stir optimally can vary. Therefore, it is desirable to have that flexibility in this system.

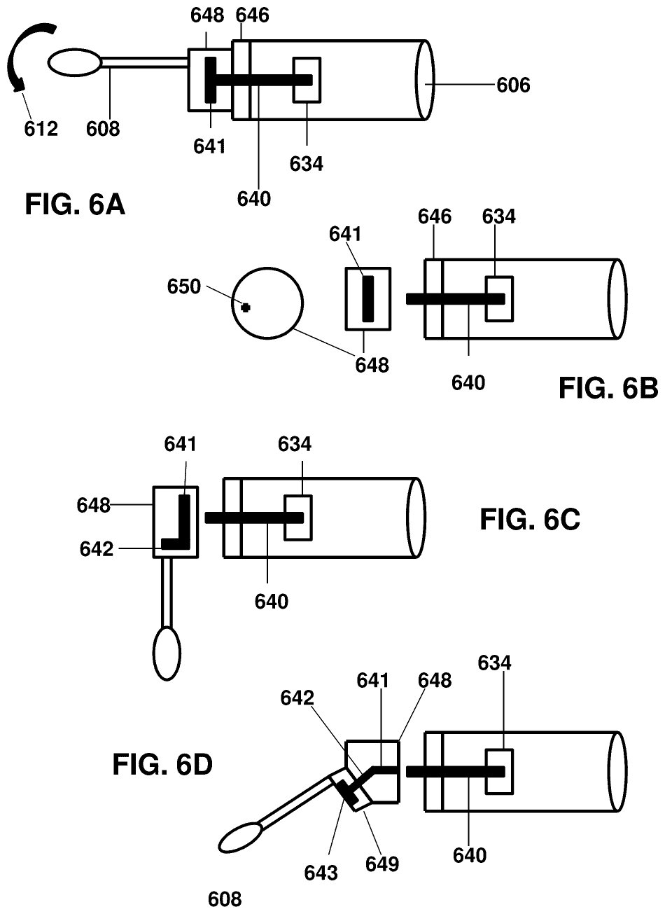

FIGS. 6A, 6B, 6C, and 6D are concept illustrations of the motor and stirrer components of the motorized stirrer. Referring to FIG. 6A, the grip bar 606 can be entirely hollow or partially hollow. Contained in the grip bar 606 is the motor device 634. This motor can be a conventional electric motor powered by a battery or other power supply. The grip bar 606 can have a controller attached to the motor. The controller can vary the direction and speed of the motor. A three-position switch with FORWARD, REVERSE, and OFF positions can control, change and stop the direction of the motor rotation. The controller can also have a switch to vary the speed of the motor rotation. Speeds such as SLOW, MEDIUM AND HIGH gives the user the flexibility to vary the speed depending on the task. Another option is to have a timer element as part of the controller to enable a user to set a predetermined time for a stirring activity. In another option, instead of terminating at the end of a time period, the stirring activity would switch to the opposite direction.

Attached to one end of the motor is a shaft 640. This shaft extends outward from the motor and out of the end of the grip bar 606. A connector section 646 can attach to the end of the grip bar 606 to connect the motor to a utensil fitting 648. As the shaft 640 extends outward from the grip bar and into the utensil fitting, it connects to a rotation bar 641 in the utensil fitting. This connection of the shaft and rotation bar forms a gear structure that rotates the utensil fitting and spoon or other utensil.

FIG. 6B shows an exploded view of the components of an embodiment of the stirring system of the present invention. The motor 634 and power source can be positioned in the grip bar. The connector section 646 is attachable to the end of the bar or a separate piece attached to the bar. The utensil fitting 648 contains the rotation bar 641. Also, on the front end surface of the utensil fitting is a connection insert 650 for attaching the stirring utensil to the fitting. Another feature can be an extension attached to the front end surface of the utensil fitting. With this configuration, the stirring utensil handle can have an that screws onto or snap onto the extension.

FIG. 6C is an alternate configuration of the stirring system of the present invention. This system enables direct downward stirring to occur. Again, the motor 634 and shaft 640 are positioned in the bar. In the utensil fitting 648 is gear configuration with bars 641 and 642. These bars provide the means to convert the vertical rotation of the shaft 640 to a horizontal motion that enables the utensil fitting to rotate horizontally and cause the stirring utensil to rotate and stir.

FIG. 6D shows an embodiment of the stirrer system with the stirring utensil in an angled position. Stirring functions can require various hand positions depending on the preference of the user and the type of activity. Sometimes, the stirrer may tilt their hand for a more desirable stirring action. In this embodiment, the utensil fitting 648 has an angled edge such that the stirring utensil is angled during stirring. In this configuration, the rotation bar 641 again attaches to motor 634 and shaft 640 on one end. The rotation bar also interacts with a second rotation bar 642. In this gear configuration, the interaction is at an angle. A common name for this gear configuration is a bevel gear. Even though these rotation bars meet at an angle, the gear concept and function are the same as other gear configurations. The rotation of bar 641 causes the rotation of bar 642. A fitting 649 attaches to the utensil fitting 648 at an angled position. Fitting 649 is connected in a manner such that it can rotate. A block 643 contained in or attached to fitting 649 facilitates the rotation of fitting 649 when the gear configuration of the rotation bars 641, 642, and 643 rotate. The stirring utensil 608 then rotates as the stirring action. There can be utensil fittings of various angles and adjustable gear configurations to provide the desired angle for any stirring activity

The system as described in FIGS. 6A through 6D can be in a modular form. For example, utensil fitting 648 can be connected to and detachable from connector section 646. Block 643 and fitting 649 can be separated from the fitting utensil 648. Internal connection configurations enable the modular connections to maintain connection integrity while rotating during stirring activities. For example, utensil fitting 648 and be screwed to connector section 646. The outer housing connects while the shaft and rotation bar will rotate the utensil fitting.

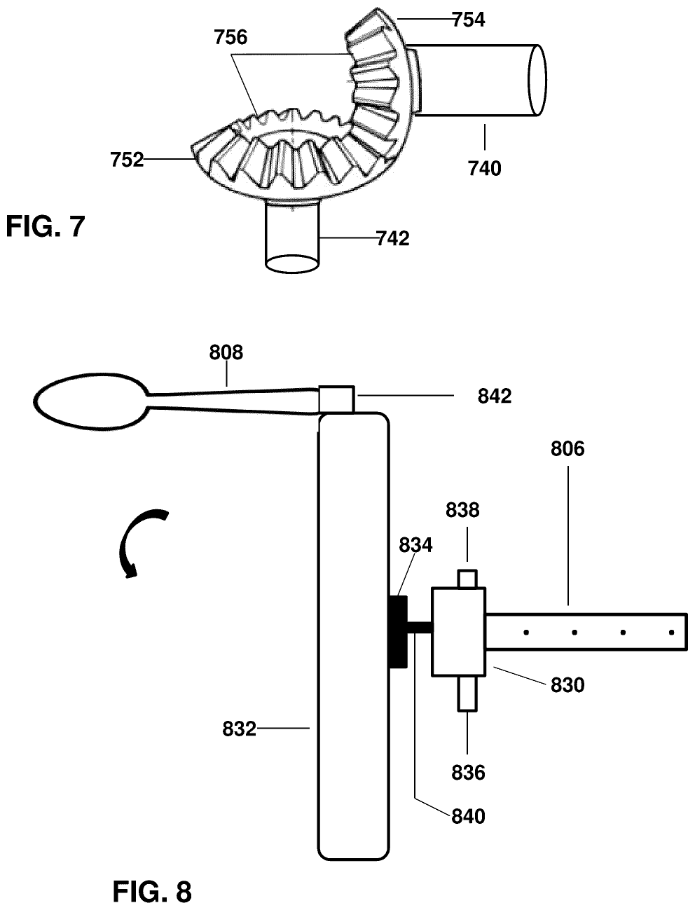

FIG. 7 illustrates the gear system that facilitates torque or rotation in the stirring process. In this configuration, shaft 740 attaches to gear 754. Bar 742 attaches to gear piece 752. Both gears 752 and 754 contain teeth 756. These teeth engage as in any conventional gear system. As gear 754 rotates with shaft 740 in a vertical direction, gear 752 rotates in a horizontal direction. The torque from the rotation of gear 752 causes bar 742 to rotate and create the stirring motion of an attached utensil.

FIG. 8 is a detailed view of an alternate embodiment of the motorized stirrer system of the present invention. A motor source 830 is attached to a belt or bar element 806. A power source 836 supplies power to the motor. This power supply could be a battery or other storage device. There is an option to provide power by plugging the device into an electrical outlet. This task could be accomplished by having some form of electrical port on the motor to receive power. A controller 838 enables the user to start the motor or change its rotation direction. As mentioned, this controller can be a three-position switch with OFF, FORWARD, and REVERSE options. This controller can also have a switch or means to vary the stirring speed. The speeds could be LOW, MEDIUM and HIGH. The motor attaches to a disc 832 that will rotate the stirring utensil 808. Element 842 can attach to the edge of disc 832. The stirring utensil 808 can attach to the element 842 via various options such as an insert or opening. The motor attaches to the disc via a shaft 840 connected to the motor, and block 834 is attached to the shaft 840 and the disc 832. The motor rotates the shaft, which rotates the bar, which rotates the disc, and the stirring utensil. This action creates the stirring motion of the utensil 808.

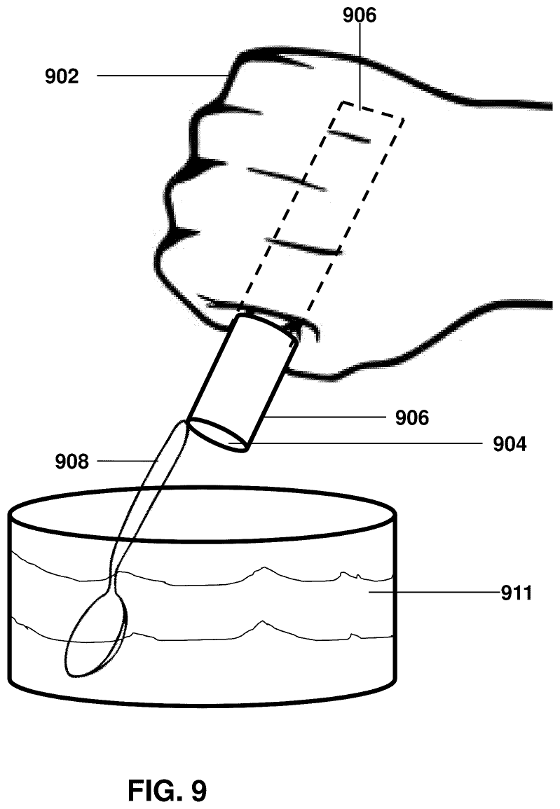

FIG. 9 is a view of the motorized stirrer system being implemented. The user's hand 902 grasps bar 906 and tilts it toward a container. The stirring utensil 908 connects to stirring attachments 906 and 904. At this point, once the stirrer starts the motor, the stirring process begins. As mentioned, this system enables the stirring activity to occur with minimal involvement of the user's wrist.

Depending on the application, a user may want to implement the stirring activity using a wide loop or a short loop. For example, if one is stirring using a large pot or bowl, they will want to stir in a wide loop and a slower circular stirring movement because of the large quantity of substance they are stirring. If the user is beating eggs in a small container, their stirring loop would be tighter and faster. The stirring utensil can be angled on the rotation element can be angled to accommodate they different stirring applications. The degree of the angle enables the user to vary the size of the stirring loop. The circumference of the stirring loop can be the same as the circumference of the rotation element. However, be angling the spoon on the rotation element, the stirring circumference can be larger or smaller than the circumference of the rotation element. Also the length of the stirring utensil impacts the size of the stirring loop. In some instances, the user may want a tight stirring circle. In other cases the user may want a wide stirring circle depending on what is being stirred.

While the description of embodiments thereof has illustrated the present invention, and while the embodiments have been described in some detail, it is not the applicant's intention to restrict or limit the scope of the invention to such information. Additional advantages and modifications will readily appear to those skilled in the art. Moreover, the invention is broader than the specific details, representative apparatus and methods, and illustrative examples shown and described in its broader aspects. Accordingly, departures may be made from such details without departing from the spirit or scope of the applicant's general inventive concept.

We claim:

1. A motorized system for stirring a substance using a utensil comprising:
a rotating disc having a front side and a back side and a continuous edge between said front and back sides, said rotating disc facilitates movement of a stirring utensil attached to the edge of said rotating disc as said rotating disc rotates in a circular direction;
a handle element attached to said back side of said rotating element to enable a user to hold during stirring activities; and
a motor element attached to said rotation disc for generating a circular torque to cause said rotating disc to spin in a circular direction, resulting in the stirring utensil moving a circular direction and creating a stirring motion when the stirring utensil is placed in a substance.

2. The motorized system for stirring a substance as described in claim 1 further comprising a flexible strap attached to said handle element to enable a user to further secure the bar to a user's hand.

3. The motorized system for stirring a substance as described in claim 1 wherein said motor element is attached to said handle at one end of said handle and said motor element also being attached to said rotating disc.

4. The motorized system for stirring a substance as described in clam 1 further comprising a shaft having two ends, a first end of said shaft being attached to said motor element and a second end of said shaft being attached to said rotation disc for transferring rotation torque from said motor element to said rotation disc.

5. The motorized system for stirring a substance as described in claim 4 further comprising a rotation bar attached said back side of said rotation disc and between said rotating disc and said shaft said rotation bar facilitating transfer of rotation torque from said motor element to said rotation disc.

6. The motorized system for stirring a substance as described in claim 1 further comprising a stirring utensil attached to said front side of said rotation disc.

7. The motorized system for stirring a substance as described in claim 5 wherein said shaft and rotation bar for a gear system for transferring torque generated by said motor element to said rotation disc.

8. The motorized system for stirring a substance as described in claim 7 wherein said gear system can be titled to different angles to position said rotation disc and a stirring utensil attached to said rotation disc angles as desired for stirring a substance.

9. The motorized system for stirring a substance as described in claim 1 further comprising:
a power source connected to said motor element to provide to said motor element; and
a controller device connect to said motor element, said controller device enabling a user to start said motor rotation in forward and reverse circular motions.

10. The motorized system for stirring a substance as described in claim 9 wherein said controller enables a user to vary the circulation speed of the rotation.

11. The motorized system for stirring a substance as described in claim 1 wherein a stirring utensil is attached to the edge of said rotating disc such that the stirring utensil can be titled in relation to the edge of the rotation disc to vary stirring angles of the stirring utensil as it stirs the substance.

12. The motorized system for stirring a substance as described in claim 1 wherein said handle element comprises a bar with two ends and a hollow section on an end of the bar wherein said motor element is positioned in the hollow section of the bar, this hollow section of the bar being the end of the bar that is connected to the rotation disc.

13. The motorized system for stirring a substance as described in claim 9 wherein said controller also contains a timer to enable a user to set motor to rotation a predetermined amount of time causing a stirring utensil to stir in a substance the predetermined amount set in the timer.

14. The motorized system for stirring a substance as described in claim 6 further comprising a stirring utensil attached to said front side of said rotation disc through an insertion in the front surface of the rotation disc.
